(19) United States
(12) Patent Application Publication
(10) Pub. No.: US 2011/0062675 A1
(43) Pub. Date: Mar. 17, 2011

(54) Wire Shopping Cart Having Foldable Seat Mechanism

(75) Inventors: Marcellar Brown, Warrensville Heights, OH (US); Frank Moses, Berea, OH (US); Ralph A. Schmitt, Hudson, OH (US); Thomas G. Stewart, Stow, OH (US); Raymond N. Uhlir, Bainbridge, OH (US)

(73) Assignee: L&P PROPERTY MANAGEMENT COMPANY, South Gate, CA (US)

(21) Appl. No.: 12/561,338

(22) Filed: Sep. 17, 2009

(51) Int. Cl. B62D 39/00

(52) U.S. Cl. 280/33.993

(57) ABSTRACT

A wire shopping cart which may be nestably stacked with numerous other such carts for storage or transport. The cart includes a wire gate and seat assembly comprising a wire gate, a wire backrest and a wire seat. The seat is pivotally mounted to the wire gate and slidably extendable through a slot of the backrest, the wire seat including a pair of outer wire U-shaped catches on opposed sides of the seat for releasably engaging a perimeter wire of the wire backrest.

### FIELD OF THE INVENTION

This invention relates generally to shopping carts, and more particularly, to a wire shopping cart having a foldable seat mechanism.

### BACKGROUND OF THE INVENTION

Shopping carts are extensively used in retail stores, such as grocery stores and department stores to facilitate handling of merchandise by customers. The shopping carts are provided with a basket having a rear gate which enables shopping carts to be nested inside one another and wheeled to a desired location. One desirable feature commonly found on shopping carts is a seat assembly for a child. Such a seat assembly commonly has a seat on which a child sits, the child facing the operator of the shopping cart. The rear gate of the basket of the shopping cart may have an opening through which the child may put his/her legs. The seat assembly typically has a backrest for the child.

One drawback with existing wire shopping carts is that the collapsible child's seat assembly may require a considerable amount of force to collapse when multiple shopping carts are nested together. Over time, store employees may suffer injuries due to the excessive force required to collapse the child's seat assemblies of the carts.

### SUMMARY OF THE INVENTION

The present invention is directed to a shopping cart comprising a gate and seat assembly. The gate and seat assembly comprises a wire gate having a first end pivotally mountable to a horizontal wire of a rear portion of a shopping cart.

A second component of the gate and seat assembly is a wire backrest comprising a perimeter wire, a seat support wire extending from one side of the perimeter wire to the other side and a back support portion. The back support portion is spaced above the seat support wire, thereby defining a slot. Lower portions of the perimeter wire are pivotally mounted to a lower portion of the wire gate to enable pivotal movement of the wire backrest relative to the wire gate.

A third component of the gate and seat assembly is a wire seat pivotally mounted to the wire gate and slidably extendable through the slot of the wire backrest, the wire seat including a pair of outer wire U-shaped catches on opposed sides of the seat for releasably engaging the perimeter wire of the wire backrest.

The seat is pivotally movable from a seating position to a collapsed position upon pivotal movement of the backrest in a first rotational direction toward the gate with the seat slidably moving through the slot of the backrest and the seat pivoting in a second rotational direction downward toward the gate until both the seat and the backrest are collapsed against the gate, wherein the first rotational direction and second rotational direction are generally opposite one another. Conversely, the seat is pivotally movable from the collapsed position to the seating position upon pivotal movement of the backrest away from the gate with the seat slidably moving through the slot of the backrest and pivoting upwardly away from the gate until the seat is in a generally horizontal orientation with the U-shaped catches of the seat in releasable contact against the perimeter wire of the backrest to maintain, in combination with gravitational forces, the seat in the seating position.

The cart may further comprise a plastic seat flap pivotally secured to the seat. The plastic seat flap is slidably movable through the slot of the backrest with the seat when the gate and seat assembly is collapsed. Alternatively, the plastic seat flap is movable to a raised position when the gate and seat assembly is collapsed so the plastic seat flap is sandwiched between the backrest and the gate when the assembly is collapsed.

According to another aspect of the present invention, a gate and seat assembly is provided for a shopping cart. The gate and seat assembly comprises a wire gate having a first end pivotally mountable to a horizontal wire of a rear portion of a shopping cart. The gate and seat assembly further comprises a wire backrest having a slot and a pair of legs and being pivotally mounted to a lower portion of the gate to enable pivotal movement of the backrest relative to the gate. The gate and seat assembly further comprises a wire seat pivotally mounted to the gate and slidably extendable through the slot of the backrest, the seat including a pair of outer wire U-shaped catches on opposed sides of the seat for releasably engaging the legs of the backrest. The seat is pivotally movable from a seating position to a collapsed position upon pivotal movement of the backrest in a first rotational direction toward the gate with the seat slidably moving through the slot of the backrest and pivoting in a second rotational direction downward toward the gate until both the seat and the backrest are collapsed against the gate, wherein the first rotational direction and second rotational direction are generally opposite one another.

Conversely, the seat is pivotally movable from the collapsed position to the seating position upon pivotal movement of the backrest away from the gate with the seat slidably moving through the slot of the backrest and pivoting upwardly away from the gate until the seat is in a generally horizontal orientation with the U-shaped catches of the seat in releasable contact against wires of the backrest to maintain, in combination with gravitational forces, the seat in the seating position.

The gate and seat assembly may further comprise a plastic seat flap pivotally secured to the seat. The plastic seat flap is slidably movable through the slot of the backrest with the seat when the gate and seat assembly is collapsed. Alternatively, the plastic seat flap is movable to a raised position when the gate and seat assembly is collapsed so the plastic seat flap is sandwiched between the backrest and the gate when the assembly is collapsed.

One advantage of the present shopping cart is that the gate and seat assembly may be collapsed with the plastic seat flap in either a raised or lowered position. Another advantage of the present shopping cart is that the gate and seat assembly may be collapsed or opened with a minimal amount of force.

These and other advantages of the present invention will more readily become apparent from the description of the drawings herein, in which:

### BRIEF DESCRIPTION OF THE DRAWINGS

FIG. 1 is a perspective view of the shopping cart of the present invention;

FIG. 2 is an enlarged perspective view of the gate and seat assembly of the shopping cart of FIG. 1 in an open position;

FIG. 3 is a perspective view of the gate and seat assembly of FIG. 2 being collapsed;

FIG. 4 is a perspective view of the gate and seat assembly of FIG. 2 in a collapsed position with the plastic seat flap in a lowered position;

FIG. 5 is a perspective view of the shopping cart of FIG. 1 showing a second shopping cart being nested inside the shopping cart of FIG. 1;

FIG. 6 is an enlarged perspective view of the gate and seat assembly of the shopping cart of FIG. 1 in an open position and the plastic seat flap in a raised position;

FIG. 6A is a top plan view of the wire seat of the gate and seat assembly of the shopping cart of FIG. 1; and

FIG. 7 is a view similar to FIG. 4, a perspective view of the gate and seat assembly of FIG. 2 in a collapsed position with the plastic seat flap in a raised position.

### DETAILED DESCRIPTION OF THE DRAWINGS

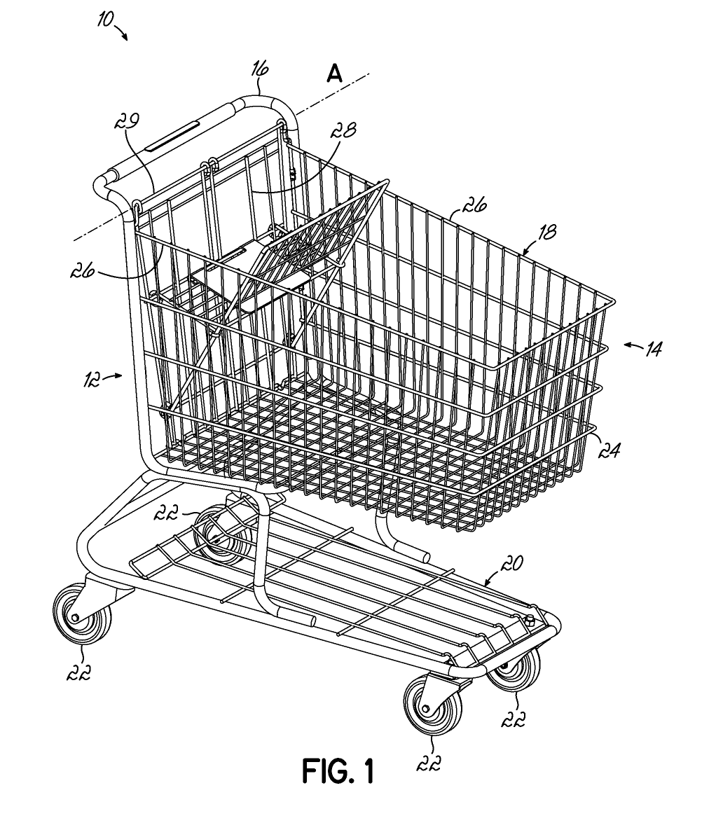

Referring to FIG. 1, a shopping cart 10, according to one embodiment of the present invention, is illustrated. The shopping cart 10 has a rear end 12 and a front end 14, for purposes of this document. A handle 16 is located at the rear of the shopping cart 10 and a wire basket 18 located generally in front of the handle 16. Below the wire basket 18 is a base 20 to which are attached four wheels 22 for moving the cart.

The wire basket 18 comprises a front wall 24, two parallel side walls 26 and a pivotal rear gate 28 which pivots about a wire 29 defining a first horizontal pivot axis A. Handle 16 facilitates moving the shopping cart 10 while the wire basket 18 provides a storage compartment for storing groceries or items while shopping.

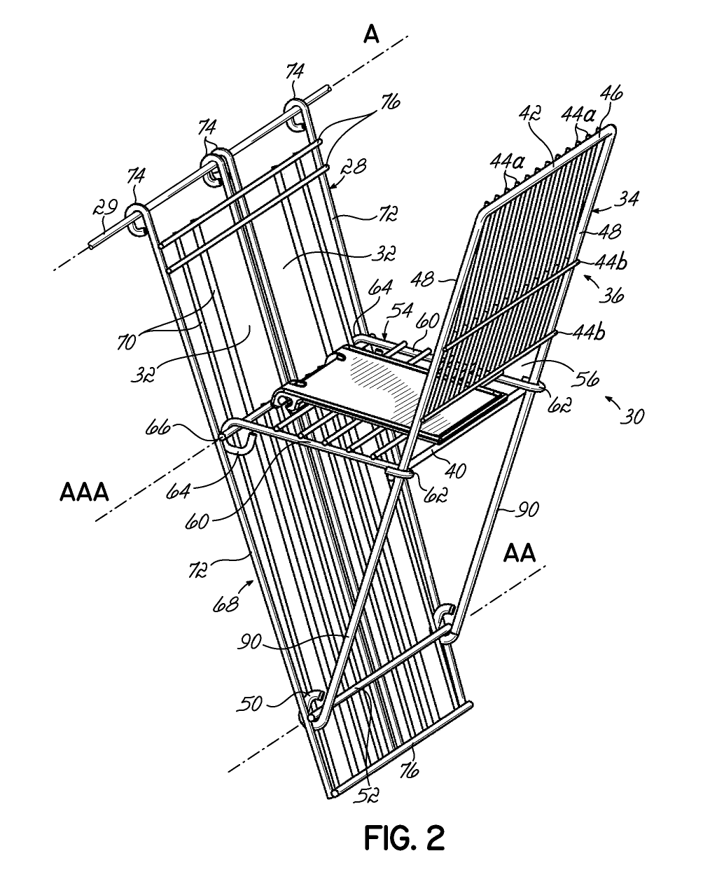

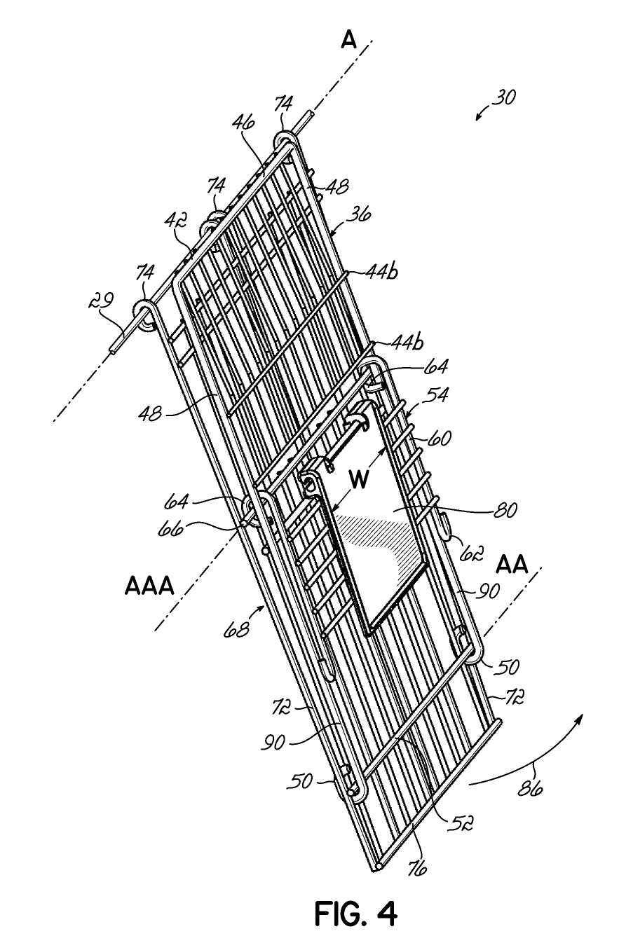

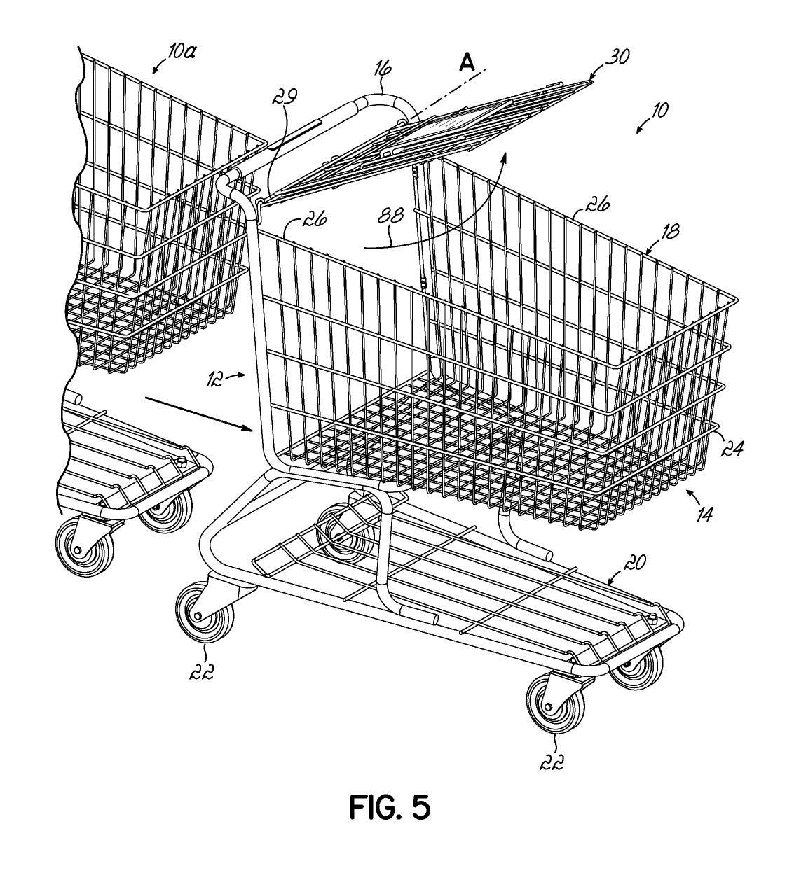

The shopping cart 10 further comprises a gate and seat assembly 30 which includes the pivotal rear gate 28. See FIG. 2. The gate and seat assembly 30 enables a child to travel in the cart while another (usually an adult, such as a parent) is operating the cart. This frees the hands of the cart operator for maneuvering the cart. The child faces rearwardly, toward the cart operator. Two leg openings 32 in the pivotal rear gate 28 enable the child rider's legs to pass therethrough. The gate and seat assembly 30 is movable between a collapsed position shown in FIG. 4 and an open position shown in FIG. 2. In its collapsed position, the assembly 30 may pivot upwardly, as shown in FIG. 5, to allow the basket of another shopping cart to nest inside the basket of the front shopping cart.

The gate and seat assembly 30, in addition to the pivotal rear gate 28, further comprises a wire backrest 34 comprising a generally rectangular back support portion 36 and a seat support wire 40 located below the back support portion 36. The wire backrest 34 has a perimeter wire 42 of a larger diameter than the wires 44a, 44b of the back support portion 36. Although the drawings illustrate a predetermined number of vertical wires 44a and two cross or horizontal wires 44b, any number of wires 44a, 44b arranged in any desired configuration or any desired size may be incorporated into the back support portion 36 of the wire backrest 34.

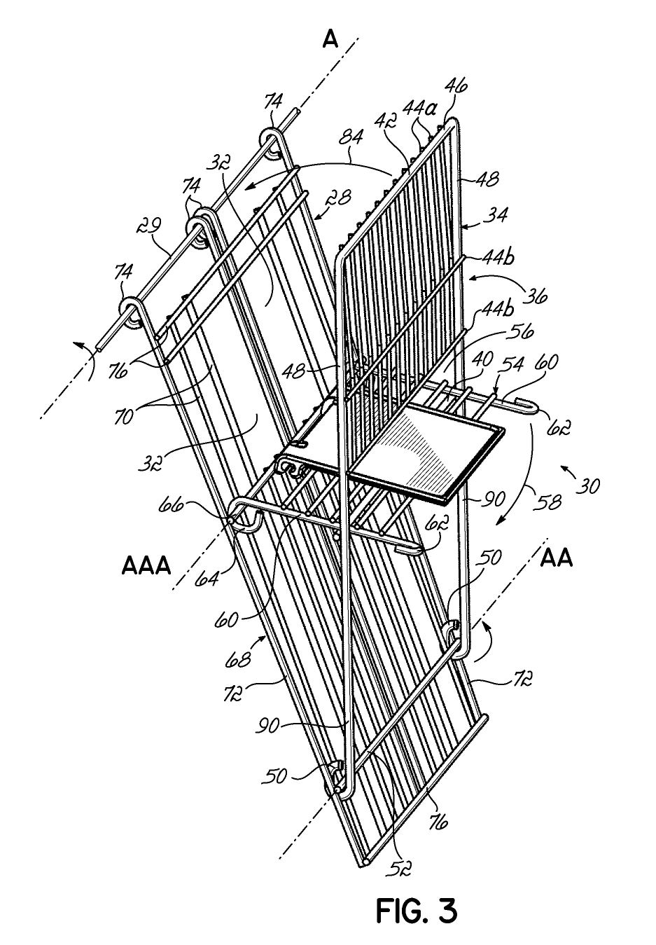

The perimeter wire 42 is generally rectangularly shaped, having a linear top portion 46 and two parallel linear spaced, side portions 48 extending downwardly from the outer ends of the linear top portion 46 of the perimeter wire 42. Each side portion 48 terminates in an end portion 50 which is circular in shape and wrapped around a cross wire 52 of the pivotal rear gate 28. This cross wire 52 defines a second horizontal pivot axis AA about which the wire backrest 34 pivots, as shown in FIG. 3.

The seat support wire 40 is illustrated as being the same gauge or diameter as the perimeter wire 42, but may be any desired gauge or diameter. The seat support wire 40 extends between the opposing side portions 48 of the perimeter wire 42 and functions as a support as the seat 54 of the gate and seat assembly 30 moves between its collapsed position shown in FIG. 4 to its seating or open position shown in FIG. 2.

A generally rectangular open area or slot 56 in the wire backrest 34 is defined by the opposing side portions 48 of the perimeter wire 42, the seat support wire 40 and the back support portion 36. The seat 54 moves through the generally rectangular slot 56 as seat 54 moves between its collapsed position shown in FIG. 4 and its seating or open position shown in FIG. 2.

As shown in FIG. 3, the wire seat 54 of the collapsible gate and seat assembly 30 is pivotal about a third horizontal pivot axis AAA between its collapsed position shown in FIG. 4 and its seating or open position shown in FIG. 2. FIG. 3 shows the wire seat 54 moving in a downward direction indicated by the arrow 58 of FIG. 3 (clockwise as shown in FIG. 3) as the seat pivots about axis AAA from its open position to its collapsed position.

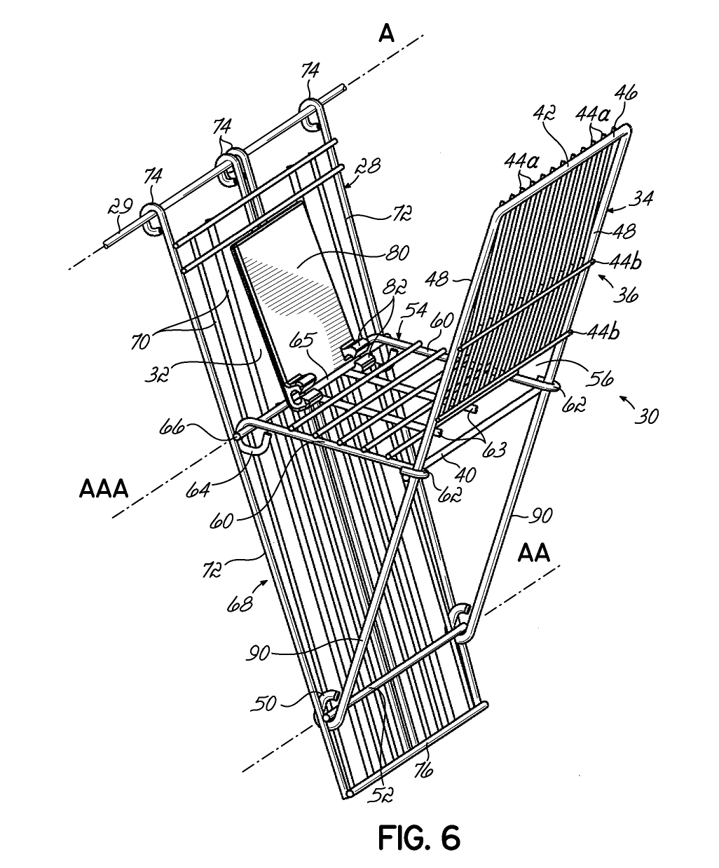

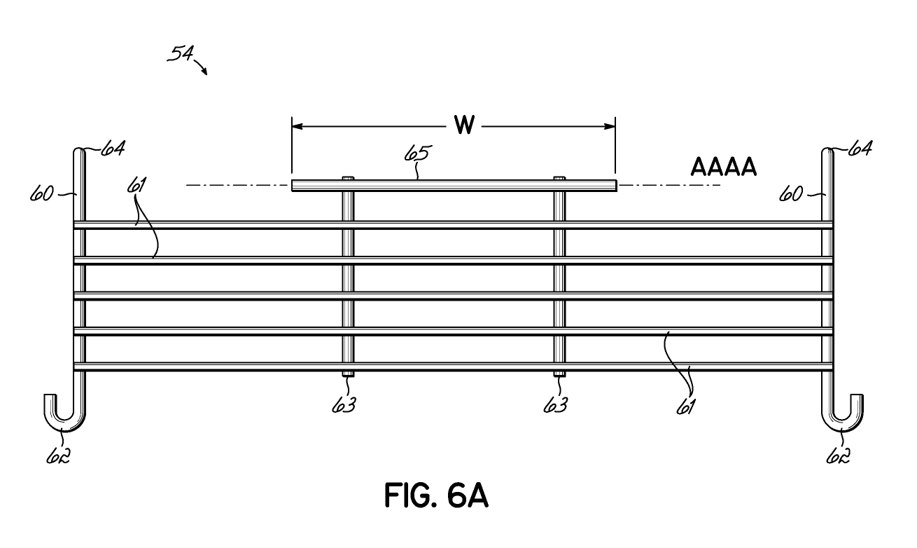

As best shown in FIG. 6A, wire seat 54 comprises two outermost wires 60, each one having a U-shaped catch 62 at the front end thereof for engaging one of the side portions 48 of the perimeter wire 42 of the wire backrest 34 to maintain the seat 54 in a horizontal position for a child to sit on. These U-shaped catches 62 at the front ends of the outermost wires 60 provide a secure means of engaging the wire seat 54 with the perimeter wire 42 of the wire backrest 34 without allowing any lateral or side-to-side movement. The perimeter wire 42 of the wire backrest 34 becomes trapped inside the U-shaped catches 62 at the front ends of the outermost wires 60 of the wire seat 54 to provide stability and structure for the collapsible gate and seat assembly 30.

As best shown in FIGS. 2-4, at the rear or other end of each of the outermost wires 60 of the seat 54 is an end portion 64 which is generally circular to pivotally secure the wire seat 54 to one of the cross wires 66 of the pivotal rear gate 28. This cross wire 66 of the pivotal rear gate 28 defines the third pivot axis AAA about which the seat 54 pivots. When collapsed, the wire seat 54 pivots downwardly, with the aid of gravity, in the direction of arrow 58, as shown in FIG. 3. As shown in FIGS. 2-4, the cross wire 66 defining the third horizontal pivot axis AAA passes through these loops or end portions 64 of the outermost wires 60 of the wire seat 54 of the gate and seat assembly 30.

As shown in FIG. 6A, wire seat 54 further comprises a plurality of parallel interior wires 61 welded or otherwise secured at their outer ends to the outermost wires 60 of the seat 54. Although five such interior wires 61 of the wire seat 54 are illustrated, any number of interior wires may be used, depending upon the desired size of the wire seat 54. Wire seat 54 further comprises a pair of spaced support wires 63 which extend perpendicular to the interior wires 61 of the wire seat 54 and may be welded or otherwise secured thereto. These support wires 63 support a flap wire 65 which is shorter in length than the interior wires 61, but extends parallel to the interior wires 61. The length of the flap wire 65 is approximately equal to the width W of the plastic seat flap 80. See FIG. 4.

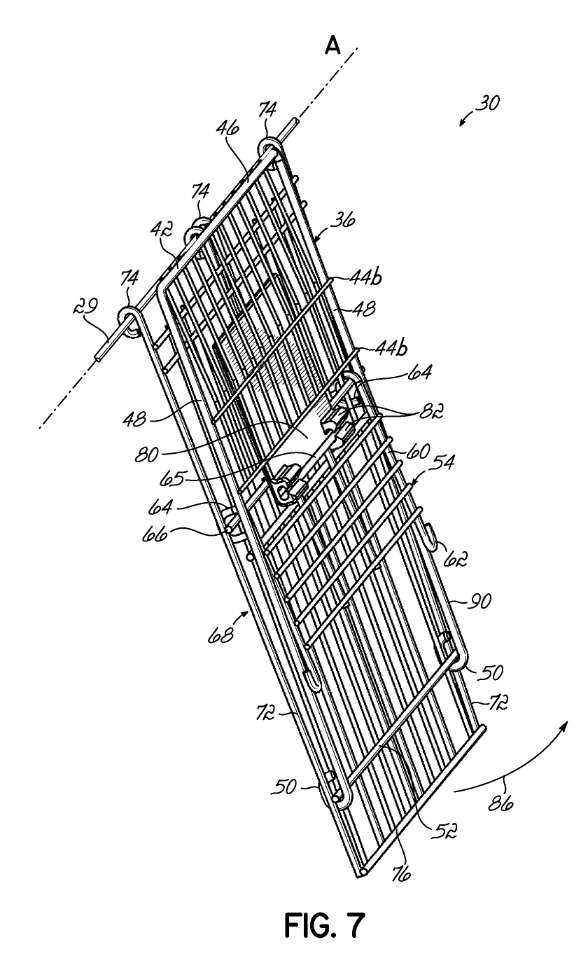

As best illustrated in FIGS. 6 and 7, the plastic seat flap 80 is pivotally secured in a snap-fit manner to the flap wire 65 of the wire seat 54 using two sets of injection molded fingers 82 of the plastic seat flap 80. The plastic seat flap 80 may be independently pivoted relative to the wire seat 54 in a manner described below.

As best shown in FIGS. 2-4, the pivotal rear gate 28 of the gate and seat assembly 30 is made of wire and comprises a generally planar grate 68. The grate 68 comprises a plurality of parallel first wires 70 oriented in a first direction, including a plurality of connecting wires 72 (four being shown) of a heavier gauge or larger in diameter than the other wires 70 of the grate 68. Each of the connecting wires 72 has an upper end portion 74 in the form of a loop. As shown in FIG. 2, the wire 29 of the shopping cart 10 defining the first horizontal pivot axis A passes through these loops or end portions 74 of connecting wires 72 of the pivotal rear gate 28 of the collapsible gate and seat assembly 30. The grate 68 of the pivotal rear gate 28 of the gate and seat assembly 30 further comprises a plurality of cross wires 76, including the cross wire 52 defining the second pivot axis AA and the cross wire 66 defining the third pivot axis AAA to which are pivotally attached the outermost wires 60 of the seat 54.

As shown in FIG. 3, to collapse or close the gate and seat assembly 30 from its open position, an operator pivots the pivotal wire backrest 34 about pivot axis AA by pulling the top portion of the wire backrest 34 rearwardly toward the pivotal rear gate 28 of the gate and seat assembly 30, as shown by the arrow 84 of FIG. 3. This movement causes the pivotal wire backrest 34 to pivot about pivot axis AA in a counter-clockwise direction, as shown in FIG. 3. The lower portions of the side portions 48 of the perimeter wire 42 of the wire backrest 34 or legs 90 (below the seat support wire 40 of the wire backrest 34) slide along the outermost wires 60 of the seat 54 in a rearward direction toward the pivotal wire rear gate 28 of the gate and seat assembly 30. This movement of the pivotal wire backrest 34 about axis AA causes the wire seat 54 and plastic seat flap 60 resting on top of the wire seat 54 to pass through the slot 56 of the pivotal wire backrest 34, sliding on top of the seat support wire 40. Thus, the wire seat 54 (with plastic seat flap 60 attached) pivots about third pivot axis AAA in the direction of arrow 58 in a clockwise direction as shown in FIG. 3 and opposite the direction of movement of wire backrest 34 depicted by arrow 84.

FIG. 4 shows the gate and seat assembly 30 in a fully collapsed position with the plastic seat flap 60 outside the wire seat 54. As shown in FIG. 5, when a second shopping cart 10a is pushed against the collapsed gate and seat assembly 30 as shown in FIG. 4, the collapsed gate and seat assembly 30 pivots about first pivot axis A in a direction shown by arrow 86 in FIG. 4 and arrow 88 in FIG. 5. The ability of the collapsed gate and seat assembly 30 of shopping cart 10 to pivot upwardly in the direction of arrow 88 of FIG. 5 enables the basket of shopping cart 10a to nest inside the interior of basket 18 of shopping cart 10.

FIG. 6 illustrates the gate and seat assembly 30 of shopping cart 10 in an open position, like FIG. 2. However, the plastic seat flap 80 is pivoted about pivot axis AAAA (see FIG. 6A) upwardly to a raised position, the fingers 82 of the plastic seat flap 80 still being engaged with the flap wire 65 of the wire seat 54. The flap wire 65 of the wire seat 54 defines yet another horizontal pivot axis AAAA about which the plastic seat flap 80 pivots. See FIG. 6A.

FIG. 7 illustrates the gate and seat assembly 30 of shopping cart 10 in a collapsed position, like FIG. 4. However, the plastic seat flap 80 is pivoted upwardly to a raised position, the fingers 82 of the plastic seat flap 80 still being engaged with the flap wire 65 of the wire seat 54 before the gate and seat assembly 30 is collapsed. The gate and seat assembly 30 may be collapsed with the plastic seat flap 80 in its raised position. Therefore, the plastic seat flap 80 ends up sandwiched between the pivotal wire backrest 34 and the pivotal rear gate 28, as shown in FIG. 7.

One advantage of the present invention is that it facilitates easy opening and closing of the collapsible gate and seat assembly of a shopping cart. This improved performance, in part, derives from the configuration of the wires. The wire collapsible gate and seat assembly may be manufactured to meet specific resiliency requirements, for example, the collapsible gate and seat assembly may be manufactured to support children safely within certain weight or size limits.

While we have described several embodiments of our invention, those persons skilled in the art will readily recognize modifications and changes which may be made without departing from the spirit or scope of the invention. Accordingly, we intend for our invention to be limited only by the following claims:

We claim:

1. A gate and seat assembly for a shopping cart comprising:
a wire gate having a first end pivotally mountable to a horizontal wire of a rear portion of a shopping cart;
a wire backrest having a slot and a pair of legs and being pivotally mounted to a lower portion of the gate to enable pivotal movement of the backrest relative to the gate;
a wire seat pivotally mounted to the gate and slidably extendable through the slot of the backrest, the seat including a pair of outer wire U-shaped catches on opposed sides of the seat for releasably engaging the legs of the backrest; and
wherein the seat is pivotally movable from a seating position to a collapsed position upon pivotal movement of the backrest in a first rotational direction toward the gate with the seat slidably moving through the slot of the backrest and pivoting in a second rotational direction downward toward the gate until both the seat and the backrest are collapsed against the gate, wherein the first rotational direction and second rotational direction are generally opposite one another.

2. The assembly of claim 1 wherein the seat is pivotally movable from the collapsed position to the seating position upon pivotal movement of the backrest away from the gate with the seat slidably moving through the slot of the backrest and pivoting upwardly away from the gate until the seat is in a generally horizontal orientation with the U-shaped catches of the seat in releasable contact against wires of the backrest to maintain, in combination with gravitational forces, the seat in the seating position.

3. The assembly of claim 1 further comprising a plastic seat flap pivotally secured to said seat.

4. The assembly of claim 3 wherein the plastic seat flap is slidably movable through the slot of the backrest with the seat when the gate and seat assembly is collapsed.

5. A gate and seat assembly for a shopping cart comprising:
a wire gate having a first end pivotally mountable to a horizontal wire of a rear portion of a shopping cart;
a wire backrest comprising a perimeter wire, a seat support wire extending from one side of the perimeter wire to the other side and a back support portion, said back support portion being spaced above said seat support wire, thereby defining a slot, lower portions of said perimeter wire being pivotally mounted to a lower portion of the wire gate to enable pivotal movement of the wire backrest relative to the wire gate;
a wire seat pivotally mounted to the wire gate and slidably extendable through the slot of the wire backrest, the wire seat including a pair of outer wire U-shaped catches on opposed sides of the seat for releasably engaging the perimeter wire of the wire backrest; and
wherein the seat is pivotally movable from a seating position to a collapsed position upon pivotal movement of the backrest in a first rotational direction toward the gate with the seat slidably moving through the slot of the backrest and the backrest pivoting in a second rotational direction downward toward the gate until both the seat and the backrest are collapsed against the gate, wherein the first rotational direction and second rotational direction are generally opposite one another.

6. The assembly of claim 5 wherein the seat is pivotally movable from the collapsed position to the seating position upon pivotal movement of the backrest away from the gate with the seat slidably moving through the slot of the backrest and pivoting upwardly away from the gate until the seat is in a generally horizontal orientation with the U-shaped catches of the seat in releasable contact against the perimeter wire of the backrest to maintain, in combination with gravitational forces, the seat in the seating position.

7. The assembly of claim 5 further comprising a plastic seat flap pivotally secured to said seat.

8. The assembly of claim 7 wherein the plastic seat flap is slidably movable through the slot of the backrest with the seat when the gate and seat assembly is collapsed.

9. The assembly of claim 7 wherein the plastic seat flap is movable to a raised position when the gate and seat assembly is collapsed so the plastic seat flap is sandwiched between the backrest and the gate.

10. A shopping cart comprising:
a gate and seat assembly comprising a wire gate having a first end pivotally mountable to a horizontal wire of a rear portion of a shopping cart;
a wire backrest comprising a perimeter wire, a seat support wire extending from one side of the perimeter wire to the other side and a back support portion, said back support portion being spaced above said seat support wire, thereby defining a slot, lower portions of said perimeter wire being pivotally mounted to a lower portion of the wire gate to enable pivotal movement of the wire backrest relative to the wire gate;
a wire seat pivotally mounted to the wire gate and slidably extendable through the slot of the wire backrest, the wire seat including a pair of outer wire U-shaped catches on opposed sides of the seat for releasably engaging the perimeter wire of the wire backrest; and
wherein the seat is pivotally movable from a seating position to a collapsed position upon pivotal movement of the backrest in a first rotational direction toward the gate with the seat slidably moving through the slot of the backrest and the backrest pivoting in a second rotational direction downward toward the gate until both the seat and the backrest are collapsed against the gate, wherein the first rotational direction and second rotational direction are generally opposite one another.

11. The cart of claim 10 wherein the seat is pivotally movable from the collapsed position to the seating position upon pivotal movement of the backrest away from the gate with the seat slidably moving through the slot of the backrest and pivoting upwardly away from the gate until the seat is in a generally horizontal orientation with the U-shaped catches of the seat in releasable contact against the perimeter wire of the backrest to maintain, in combination with gravitational forces, the seat in the seating position.

12. The cart of claim 10 further comprising a plastic seat flap pivotally secured to said seat.

13. The cart of claim 12 wherein the plastic seat flap is slidably movable through the slot of the backrest with the seat when the gate and seat assembly is collapsed.

14. The cart of claim 12 wherein the plastic seat flap is movable to a raised position when the gate and seat assembly is collapsed so the plastic seat flap is sandwiched between the backrest and the gate.

15. A shopping cart comprising:
a wire gate and seat assembly comprising a wire gate having a first end pivotally mountable to a portion of a shopping cart;
a wire backrest comprising a perimeter wire, a seat support wire extending from one side of the perimeter wire to the other side and a back support portion, said back support portion being spaced above said seat support wire, thereby defining a slot, lower portions of said perimeter wire being pivotally mounted to a lower portion of the wire gate to enable pivotal movement of the wire backrest relative to the wire gate;
a wire seat pivotally mounted to the wire gate and slidably extendable through the slot of the wire backrest, the wire seat including a pair of outer wire U-shaped catches on opposed sides of the seat for releasably engaging the perimeter wire of the wire backrest; and
wherein the seat is pivotally movable from a seating position to a collapsed position upon pivotal movement of the backrest in a first rotational direction toward the gate with the seat slidably moving through the slot of the backrest and the backrest pivoting in a second rotational direction downward toward the gate until both the seat and the backrest are collapsed against the gate, wherein the first rotational direction and second rotational direction are generally opposite one another.

16. The cart of claim 15 wherein the seat is pivotally movable from the collapsed position to the seating position upon pivotal movement of the backrest away from the gate with the seat slidably moving through the slot of the backrest and pivoting upwardly away from the gate until the seat is in a generally horizontal orientation with the U-shaped catches of the seat in releasable contact against the perimeter wire of the backrest to maintain, in combination with gravitational forces, the seat in the seating position.

17. The cart of claim 15 further comprising a plastic seat flap pivotally secured to said seat.

18. The cart of claim 15 wherein the plastic seat flap is slidably movable through the slot of the backrest with the seat when the gate and seat assembly is collapsed.

19. The cart of claim 18 wherein the plastic seat flap is movable to a raised position when the gate and seat assembly is collapsed so the plastic seat flap is sandwiched between the backrest and the gate.
